(19) United States
(12) Patent Application Publication
(10) Pub. No.: US 2004/0110520 A1
(43) Pub. Date: Jun. 10, 2004

(54) Dynamic scanning receiver/amplifier

(76) Inventors: Frank S. Barbara, Scarsdale, NY (US); Lee Masoian, West New York, NJ (US); Richard L. Harvey, Neshanic Station, NJ (US)

Correspondence Address: DARBY & DARBY P.C., P. O. BOX 5257, NEW YORK, NY, 10150-5257, US

(21) Appl. No.: 10/314,878

(22) Filed: Dec. 9, 2002

(51) Int. Cl. H04Q 7/00

(52) U.S. Cl. 455/506; 455/232.1

(57) ABSTRACT

An amplifier system having an amplifier for amplifying a communications signal, a scanning receiver for monitoring a signal strength of the communications signal, a microprocessor for determining, based on the signal strength of the communications signal, whether the communications signal should be amplified, and a switch, controlled by the microprocessor, for allowing the communications signal to pass through the amplifier or be terminated.

### TECHNICAL FIELD OF THE INVENTION

The present invention relates to a dynamic scanning receiver/amplifier, and more specifically to an amplifier system that is controlled in accordance with a received signal strength.

### SUMMARY OF THE INVENTION

A purpose of the invention is to turn a band-limited amplifier system on or off based on a received signal strength of multiple types of signals, such as narrowband AMPS signals, wideband CDMA signals, TDMA signals, GSM signals, 3G signals, Nextel signals, etc. in a communications frequency band. If the signals from the cell site are weak (defined as being below a predetermined strength threshold) the bi-directional amplifier is turned on or activated. If the signals from the cell site are strong (defined as being above the threshold) the bi-directional amplifier is shut off so as to not allow excess noise into the communications network. The system can also use the received signal strength to adjust the gain of the bi-directional amplifier.

Another purpose of the invention is to avoid multipath problems. When the booster is near a cell site the cell site signals dominate; and when the booster is far from the cell site the booster signals dominate. Somewhere in the middle of these points multi-path problems occur. That is, the signal strengths will be comparable and out of phase, will cancel each other out. The booster is therefore turned off at this point so as to prevent this from occurring.

The system of the invention has numerous applications. For example, the system can be used on moving platforms (e.g., trains) where the signal environment is constantly changing or in fixed locations that have a dynamic signal environment. Examples of dynamic environments include airports, sea ports and nearby roadways. These environments are dynamic because airplanes, ships and truck traffic can obstruct signals. The system amplifies signals from a strong signal strength location (e.g., roof of building or train) to a low or no signal strength location (e.g., inside building or train).

### BRIEF DESCRIPTION OF THE DRAWINGS

FIG. 1 illustrates a downlink portion of an amplifier system of the present invention.

FIG. 2 illustrates a GPS receiver included with the amplifier system of FIG. 1.

FIG. 3 illustrates downlink and uplink portions of the amplifier system of FIG. 1.

FIG. 4 illustrates a GPS receiver included with the amplifier system of FIG. 3.

FIG. 5 illustrates downlink and uplink portions of an amplifier system in which multiple channels are monitored and amplified.

FIG. 6 illustrates a scanning receiver spectrum.

### DETAILED DESCRIPTION OF THE INVENTION

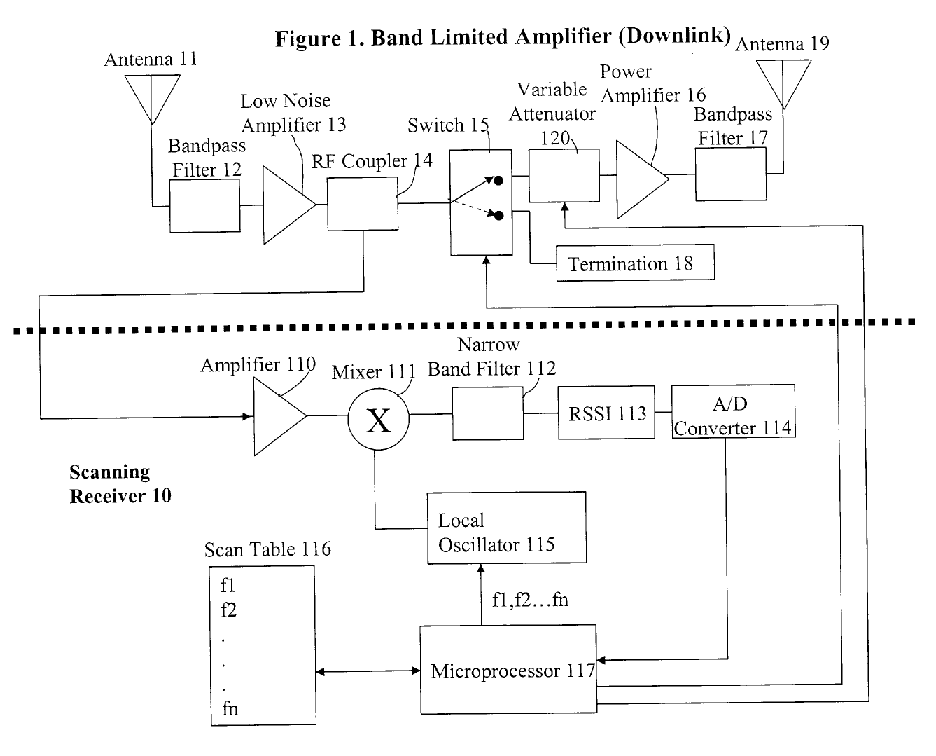

The amplifier system of the present invention essentially moves a signal from a location where there is adequate signal coverage to a location where signal coverage is inadequate. FIG. 1 illustrates a downlink portion of an amplifier system of the present invention. A donor antenna 11 is located, for example, on a roof where there is adequate signal coverage, and a server antenna 19 is located, for example, within a building or a train car where signal coverage may not be as adequate.

After a communications signal is received at donor antenna 11, bandpass filter 12 filters out from the received signal any undesired frequencies, for example, frequencies of other carriers, and the signal is amplified by low noise amplifier 13, which has a fixed gain. The RF coupler 14 then passes most of the signal through to switch 15, but taps off a small portion of the signal strength to be used for monitoring by the scanning receiver 10, which is shown in the lower half of FIG. 1.

The scanning receiver 10, the operation of which is described in more detail further below, monitors the signal strength of the multiple types of signals and makes a determination as to whether the switch 15 should be turned on/off and whether gain of the communications signal should be adjusted using variable attenuator 120. The determination is made based on priority of the various signal types. For example the user may determine that in a certain location or at a certain time a CDMA signal is more important to amplify than an AMPS signal. In this area or during this time the bi-directional amplifier gain can be adjusted based on the received signal strength of the CDMA signal. During other times or at other locations the user may place the priority on the AMPS signals. This may be because certain regions of the country do not have one signal type or the other, whereas other areas have both.

When the bi-directional amplifier system is turned off, switch 15 is positioned in the “off” position (shown by the dotted arrow), and the signal is terminated at termination 18, which absorbs the signal energy. When the bi-directional amplifier system is turned on, switch 15 is positioned in the “on” position (shown by the solid arrow), and the signal is passed through the variable attenuator 120 to power amplifier 16, which amplifies the signal and has a fixed gain. Bandpass filter 17 then filters out spurious signals (e.g., other carriers' signals) that may have been inadvertently passed by bandpass filter 12. Finally, the signal is transmitted by antenna 19, which may be located, for example, inside a building or a train.

The operation of the scanning receiver 10, shown in the lower half of FIG. 1, will now be described.

As discussed above, a small portion of the received communications signal strength is coupled off by the RF coupler 14 and used by the scanning receiver 10 to monitor signal strength. This signal portion is amplified by amplifier 110 and then down-converted by mixer 111 to an intermediate frequency (IF) (e.g., from 800 MHz to 90 MHz) so that the signal may be more sharply filtered by narrow band filter 112 (which is, for example, 30 kHz wide for AMPS signals, and 1.25 MHz wide for CDMA signals) and tuned to a particular narrow band of frequencies. Mixer 111 down-converts, that is, tunes to a particular frequency band, by combining the amplified signal from amplifier 110 with a signal having a frequency set by local oscillator (LO) 115. Microprocessor 117 controls the LO frequency in accordance with user-loaded data that is stored in scan table 116. After the IF signal is filtered by narrow band filter 112, the signal strength of the particular channel is determined by received signal strength indicator (RSSI) 113. The IF signal is then converted from analog to digital by A/D converter 114, and the digital data representing the signal strength is sent to microprocessor 117 and stored with its associated frequency in scan table 116. This process is repeated for each frequency in scan table 116. After the entire table of frequencies is scanned, a determination is made by the microprocessor 117, based upon the signal strength information stored in the scan table 116, as to whether the bi-directional amplifier system should be turned off or turned on to amplify the received communications signal by a particular gain. When the amplification occurs, all frequencies in the received signal are amplified by they same amount.

The threshold used by the microprocessor 117 to determine whether the signal strength warrants turning off the bi-directional amplifier system is user-defined and may be based on any of a number of factors. For example, the threshold could be based on the signal strength of any one channel of the communications signal, the signal strength of any one of a subset of channels, or even the total signal strength of a subset of channels. The threshold could also be based on the average signal strength of all or a subset of channels. If the microprocessor 117 determines that the signal strength is above the predetermined threshold, the microprocessor 117 turns the bi-directional amplifier system off by commanding switch 15 to be positioned in the terminated position (shown by the dotted arrow). If, on the other hand, the microprocessor 117 determines that the signal strength is below the predetermined threshold, the microprocessor 117 turns the bi-directional amplifier system on by commanding switch 15 to be positioned in the amplified position (shown by the solid arrow). The signal then passes through variable attenuator 120, is amplified by power amplifier 16, filtered by band pass filter 17 to filter out other carriers' signals, and rebroadcast out by server antenna 19.

In addition to using signal strength to determine whether the bi-directional amplifier system should be turned on or off, this signal strength can be used to determine whether the gain of the bi-directional amplifier system should be adjusted. The amount of gain adjustment may be determined by using either a gain table or a mathematical calculation. Should the microcontroller 117 determine that gain adjustment is warranted, the microcontroller 117 would send a signal indicating the amount of gain to the variable attenuator 120.

While FIG. 1 illustrates a downlink system, it should be appreciated by those skilled in the art that the system of FIG. 1 could be reversed to be an uplink system. That is, rather than the signal being received from antenna 11 and then transmitted (or prevented from being transmitted) via antenna 19, the signal could be received by antenna 19 and transmitted via antenna 11. The downlink system monitors and amplifies incoming signals (e.g., from outside to inside of a building), whereas the uplink system does the same for outgoing signals (e.g., from inside to outside of a building).

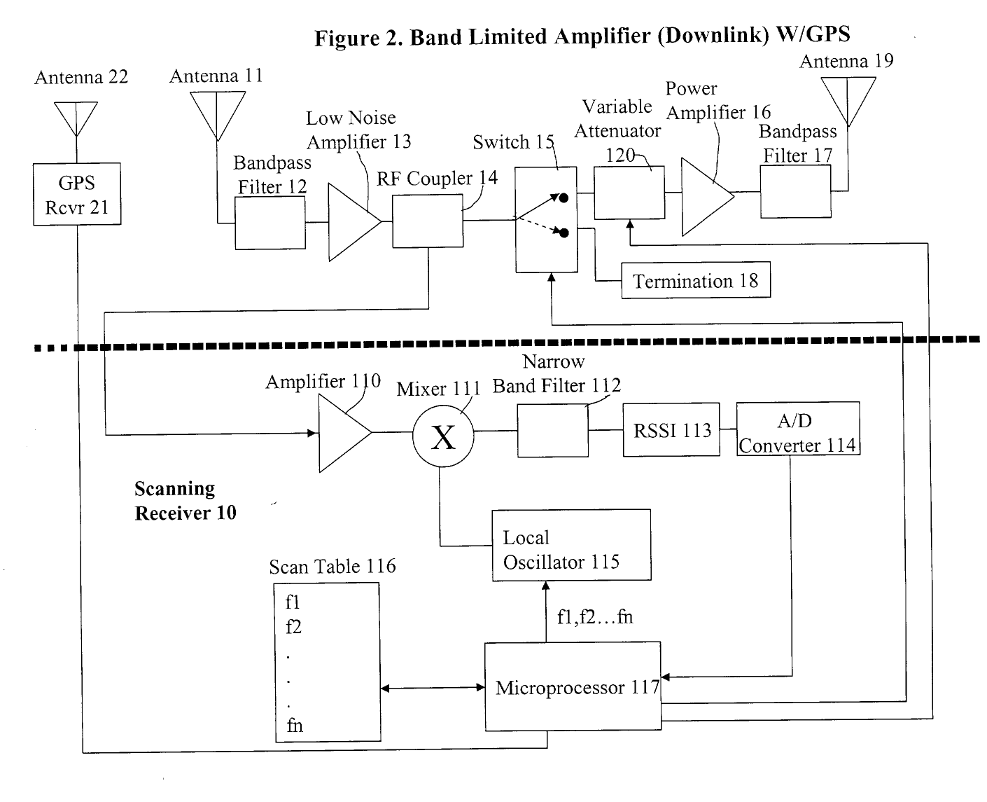

FIG. 2, which illustrates another aspect of the present invention, is similar to FIG. 1, except that the system of FIG. 2 includes a GPS (global positioning system) antenna 22 and receiver 21. The GPS antenna 22 and receiver 21 are used to determine the location of the bi-directional amplifier system. The location information is input to microprocessor 117, which uses the position information to determine a particular frequency set that should be used in the scan table 116. This GPS feature is generally useful in applications in which the system is placed on a moving conveyance, such as a train. This is because a same carrier may use different frequencies in different areas due to different jurisdictions issuing their own communication licenses for its particular area. For example, a carrier subscriber may use one set of frequencies in the Washington, D.C. area and a completely different set of frequencies in Connecticut. The system of the invention thus automatically adjusts to the proper frequencies for the current location. Also, certain geographical areas are known to have poor or strong reception, and the gain settings and on/off control can be predetermined based on the train's location.

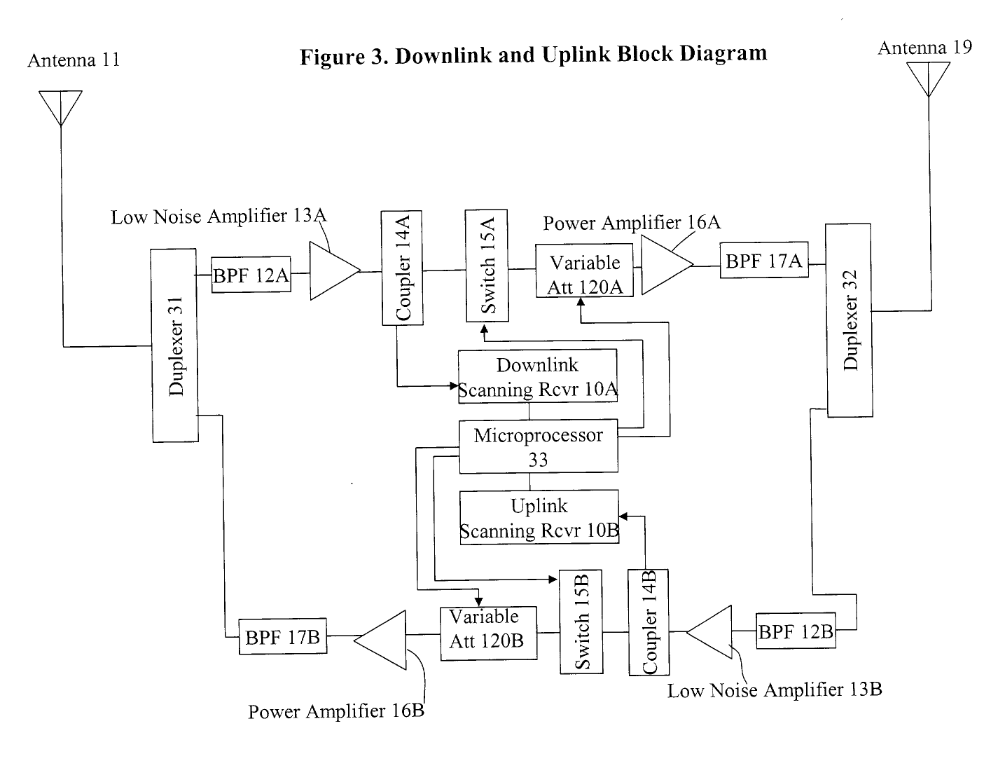

FIG. 3 illustrates an amplifier system in accordance with another aspect of the present invention. While FIG. 1 includes only a downlink system, FIG. 3 includes both uplink and downlink portions. As described above, the downlink portion, which monitors and amplifies incoming signals, receives a signal from antenna 11 and then transmits (or prevents transmission) via antenna 19. On the other hand, the uplink portion, which monitors and amplifies outgoing signals, receives a signal from antenna 19 and transmits via antenna 11. The duplexers 31 and 32 are each comprised of two filters, which separate the uplink and downlink portions.

The downlink portion of the amplifier system receives an incoming signal via antenna 11. After passing through duplexer 31, which separates the downlink portion from the uplink portion, the remainder of the downlink portion operates in a manner similar to that described with respect to the downlink system of FIG. 1. That is, after the signal passes through band pass filter 12A, which filters out undesired frequencies, and is amplified by low-noise amplifier 13A, the RF coupler 14A passes most of the signal through to switch 15 (15A is shown for the downlink portion) and simultaneously taps off a small portion of the signal strength to be used for monitoring by the scanning receiver 10A, as described above with respect to FIG. 1 (indicated in FIG. 1 by reference numeral 10).

The microprocessor 33 controls the switch 15A. When the switch 15A is in the “off” position, the communications signal is terminated. When the switch 15A is in the “on” position, the signal is sent through variable attenuator 120A to the power amplifier 16A. Bandpass filter 17A then filters out spurious signals, and the filtered signal passes through duplexer 32 and is transmitted via antenna 19.

Since some of the elements of the downlink portion of FIG. 3 are the same as the downlink amplifier system of FIG. 1, the same or similar references numerals have been used.

The uplink portion of the amplifier system of FIG. 3 is substantially similar to the downlink portion, except that operation in the reverse direction. And although a single scanning receiver 10 could have been used for both portions, the example of FIG. 3 is more versatile in that it includes a scanning receiver 10A, 10B for each of the uplink and downlink portions. That is, the uplink and downlink portions are monitored independently rather than together.

Although the uplink and downlink portions may be independently controlled, they are preferably coupled. Also, although the coupled uplink and downlink portions could be controlled based on the monitored signal strength of the uplink portion, it is usually the monitored signal strength of the downlink portion that is used. When the booster is near a cell site, the downlink signal strength (i.e., the signal strength from the cell site) is strong, and both the uplink and downlink portions are turned off so as to prevent the booster from producing excessive noise to the network and multipath problems in the coverage area.

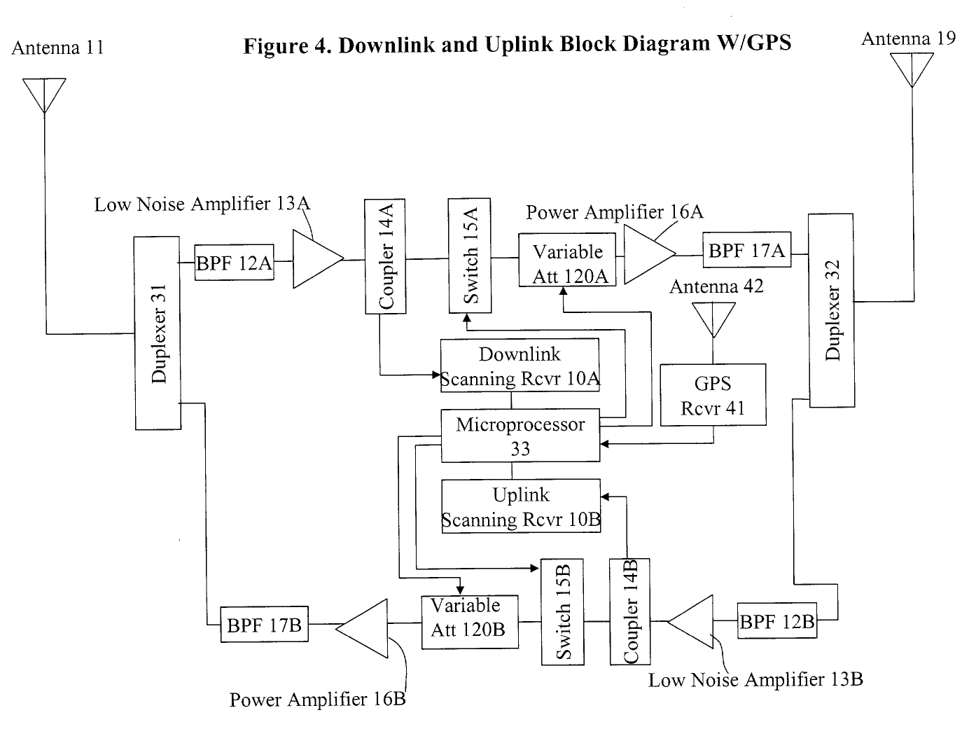

FIG. 4, which illustrates an amplifier system in accordance with another aspect of the present invention, is similar to FIG. 3, except that the system of FIG. 4 includes a GPS (global positioning system) antenna 42 and receiver 41. The GPS feature of FIG. 4 operates in a manner similar to the GPS feature of FIG. 2, and therefore no additional explanation is believed necessary.

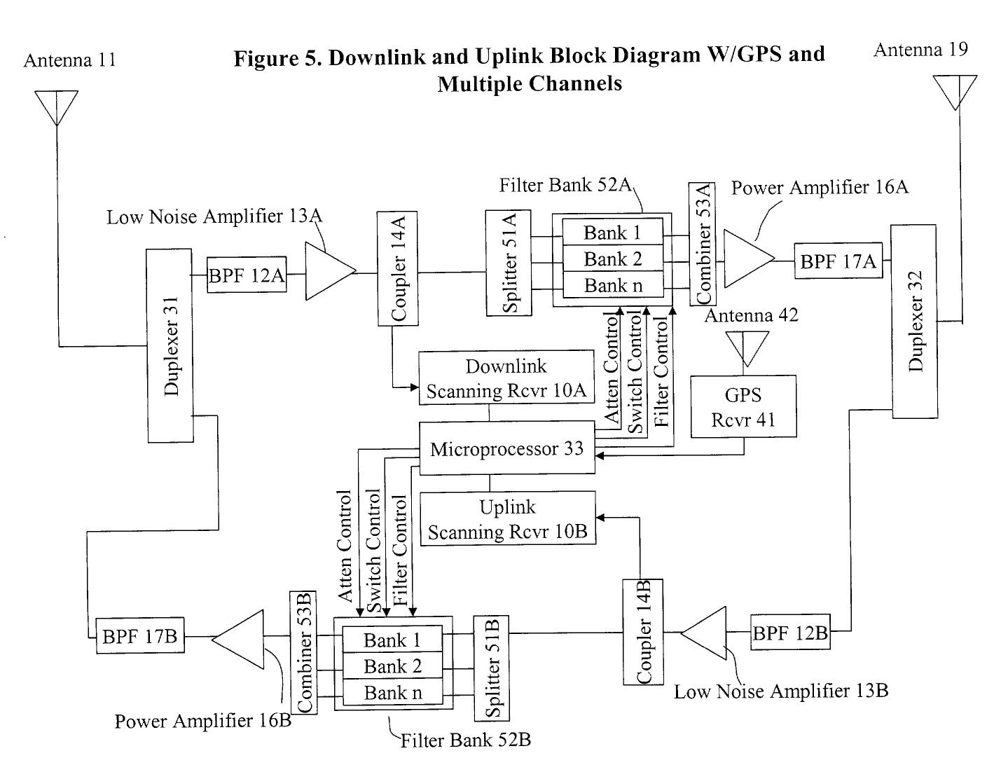

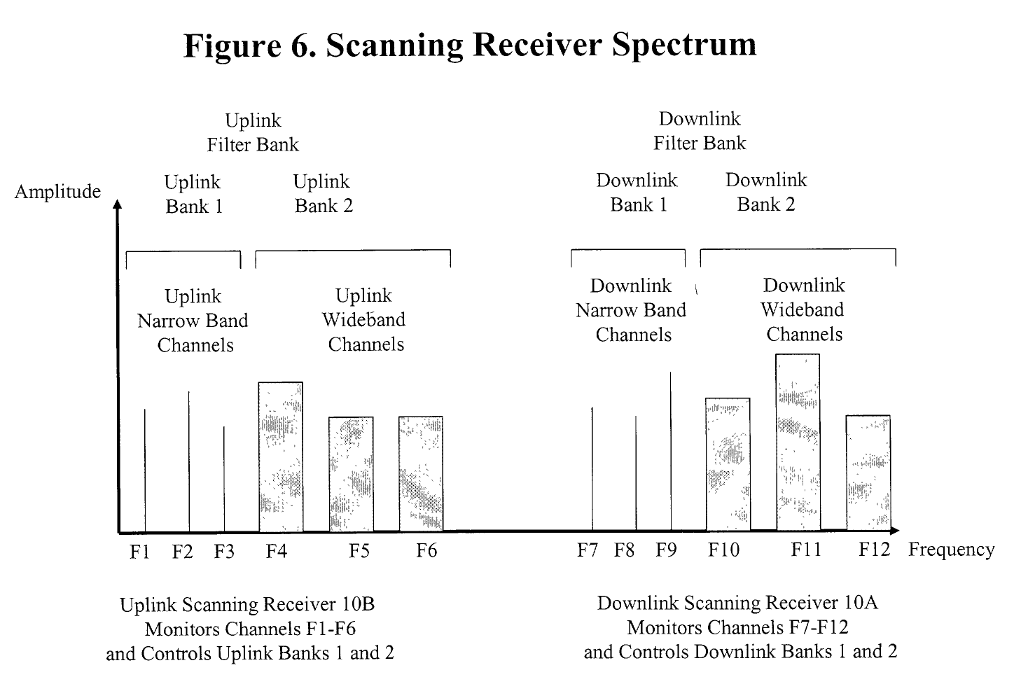

FIG. 5 illustrates an amplifier system, which amplifies multiple channels of a communications signal. Duplexer 31, which operates similarly to duplexer 31 in FIGS. 3 and 4 (i.e., separates uplink and downlink portions), transmits the downlink signal through to bandpass filter 12A, low noise amplifier 13A and coupler 14A. Splitter 51A then splits the downlink signal into multiple paths or channels, and filter bank 52A, which includes channel banks 1 through n, frequency selects and amplifies the individual channels. The filter bank 52A includes a filter, a switch and a variable attenuator for each of the channels, but alternatively, a single switch and a single variable attenuator can be used to control all of the channels. The filter selects a frequency band, the switch turns the frequency band on or off, and the variable attenuator controls gain, wherein microprocessor 33 controls the switch and attenuator. As shown in FIG. 6, the uplink scanning receiver 10B monitors and controls channels of filter bank 52B, which includes uplink banks 1 through n (2 in the example of FIG. 6), and the downlink scanning receiver 10A monitors and controls channels of filter bank 52A, which includes uplink banks 1 through n (2 in the example of FIG. 6). After passing through filter bank 52A, the channels are recombined in combiner 53A, amplified by power amplifier 16A, and filtered by band-pass filter 17A before being passed through duplexer 32 and transmitted via antenna 19.

The foregoing description of FIG. 5 is of the operation of the downlink portion. The uplink portion of the system operates in a similar manner but in the reverse direction. That is, after the signal passes through duplexer 32, bandpass filter 12B, low noise amplifier 13B, coupler 14B and splitter 51B, channels having selected frequencies are turned on/off and possibly gain adjusted in filter bank 52B. Finally, the channels are recombined in combiner 53B, amplified by power amplifier 16B, and filtered by band-pass filter 17B before being passed through duplexer 31 and transmitted via antenna 11. And as discussed above for FIG. 3, although the uplink and downlink portions may be independently controlled, they are preferably coupled.

Although the present invention has been described in several embodiments, a myriad of changes, variations, alterations, transformations and modifications may be suggested to one skilled in the art. It is intended that the present invention encompass such changes, variations, alterations, transformations and modifications and that they fall within the spirit and scope of the appended claims.

What we claim is:

1. An amplifier system comprising:
an amplifier for amplifying a communications signal;
a scanning receiver for monitoring a signal strength of the communications signal;
a microprocessor for determining, based on the signal strength of the communications signal, whether the communications signal should be amplified; and
a switch, controlled by the microprocessor, for allowing the communications signal to pass through the amplifier or be terminated.

2. The amplifier system of claim 1, further comprising a GPS receiver coupled to the microprocessor, wherein the determination whether the communications signal should be amplified is based upon position information from the GPS receiver.

3. The amplifier system of claim 1, wherein the microprocessor determines whether the communications signal should be amplified by comparing the monitored signal strength with a predetermined threshold.

4. The amplifier system of claim 3, wherein the threshold is based upon a signal strength of any one channel of the communications signal.

5. The amplifier system of claim 3, wherein the threshold is based upon the signal strength of any one of a subset of channels of the communications signal.

6. The amplifier system of claim 3, wherein the threshold is based upon a total signal strength of a subset of channels of the communications signal.

7. The amplifier system of claim 3, wherein the threshold is based upon an average signal strength of all or a subset of channels of the communications signal.

8. The amplifier system of claim 1, wherein the microprocessor determines, based on the monitored signal strength, whether to modify an amount of amplifier gain.

9. An amplifier system comprising:
an amplifier for amplifying a communications signal;
a splitter that splits the communications signal into multiple channels;
a microprocessor for determining, based on the signal strengths of the channels of the communications signal, whether any of the channels of the communications signal should be amplified;
a filter bank including a filter for selecting frequency bands for each of the channels, and further including for each of the channels an on/off switch, which is controlled by the microprocessor, for allowing the channel to pass through to the amplifier or be terminated; and
a combiner that recombines the channels.

10. The amplifier system of claim 9, wherein the filter bank also includes a variable attenuator for each of the channels.
